(19) United States
(12) Patent Application Publication
(10) Pub. No.: US 2021/0095738 A1
(43) Pub. Date: Apr. 1, 2021

(54) MULTIPLE FREQUENCY VIBRATION ATTENUATION DEVICE

(71) Applicant: MW Industries, Inc., Rosemont, IL (US)

(72) Inventors: Derek C. Evans, Santa Maria, CA (US); Kyle Sitton, Santa Maria, CA (US)

(21) Appl. No.: 17/034,922

(22) Filed: Sep. 28, 2020

Related U.S. Application Data
(60) Provisional application No. 62/906,813, filed on Sep. 27, 2019.

(51) Int. Cl. F16F 15/067

(52) U.S. Cl. CPC F16F 15/067; F16F 2238/026

(57) ABSTRACT

A multiple frequency vibration attenuation device comprises a mass portion and a spring portion and may attenuate vibrations at two or more different frequencies. The shape and mass of the mass portion is dependent on the spring rate and lateral bending rate of the spring and the frequencies that are desired to be attenuated. In an embodiment, two or more of the natural frequencies of the multiple frequency vibration attenuation device match the vibration frequencies of an aircraft system that are desired to be attenuated.

### CROSS-REFERENCE TO RELATED APPLICATION

This application claims priority to U.S. Provisional Application No. 62/906,813, filed Sep. 27, 2019, which is incorporated herein by reference in its entirety.

### TECHNICAL FIELD OF THE DISCLOSED EMBODIMENTS

The present invention generally relates to devices for attenuating system vibrations and, more particularly, to devices for attenuating system vibrations at multiple frequencies.

### BACKGROUND OF THE DISCLOSED EMBODIMENTS

Aircraft are subject to various undesired vibrations at multiple frequencies. Each airplane has a unique signature of normal vibration. This is a consequence of mass distribution and structural stiffness that results in vibration modes at certain frequencies. When external forces act on the airplane, such as normal airflow over the surfaces, very low-level vibrations result. Typically, this is perceived as background noise. More noticeable, but also normal, is the reaction of the airplane to turbulent air, in which the magnitude of the vibration may be larger and thus clearly visible and felt. Engine operation at some spool speeds may result in increased vibration because spool imbalance excites the engine and transmits this vibration throughout the airframe. Finally, the operation of some mechanical components, such as pumps, may be associated with normal noise and vibration.

In some applications, avoiding operating at the aircraft system's modal frequency is difficult if not impossible. Vibration attenuation is desirable to prevent wear to aircraft components and for increased comfort of the occupants of the aircraft. It is most desirable to attenuate vibrations during take-off (because high amplitude vibrations may occur while operating the engines to produce high levels of thrust) and while in flight at cruising speed (because most of the operational time of the aircraft is spent at this speed). In most cases, the frequency of vibration is different during take-off and at cruising speed. There is a need to attenuate the frequency of the overall aircraft assembly to reduce vibrations at the undesired frequencies. The present invention is directed toward meeting these needs.

### SUMMARY OF THE DISCLOSED EMBODIMENTS

In one embodiment, a multiple frequency vibration attenuation device is disclosed, comprising: a spring; and a mass attached to the spring; wherein the device comprises at least two natural frequencies; and wherein the mass is not attached to anything other than the spring.

In another embodiment, a device for attenuating vibration frequencies of an aircraft is disclosed, comprising: a spring; and a mass attached to the spring; wherein the device comprises at least two natural frequencies; wherein the mass is not attached to anything other than the spring; and wherein the device is constructed and arranged to attach to the aircraft.

Other embodiments are also disclosed.

### BRIEF DESCRIPTION OF DRAWINGS

The present invention will become more fully understood from the detailed description and the accompanying drawings, wherein:

FIG. 1 is a front perspective view of a multiple frequency vibration attenuation device in accordance with an embodiment.

FIG. 2 is a rear perspective view of the multiple frequency vibration attenuation device of FIG. 1.

FIG. 3 is a side elevational view of the multiple frequency vibration attenuation device of FIG. 1.

FIG. 4 is a cross-sectional view of the multiple frequency vibration attenuation device of FIG. 1.

FIG. 5 is a top plan view of the multiple frequency vibration attenuation device of FIG. 1.

### DETAILED DESCRIPTION OF THE VARIOUS EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated and desired to be protected. Such alternative embodiments require certain adaptations to the embodiments discussed herein that would be obvious to those skilled in the art.

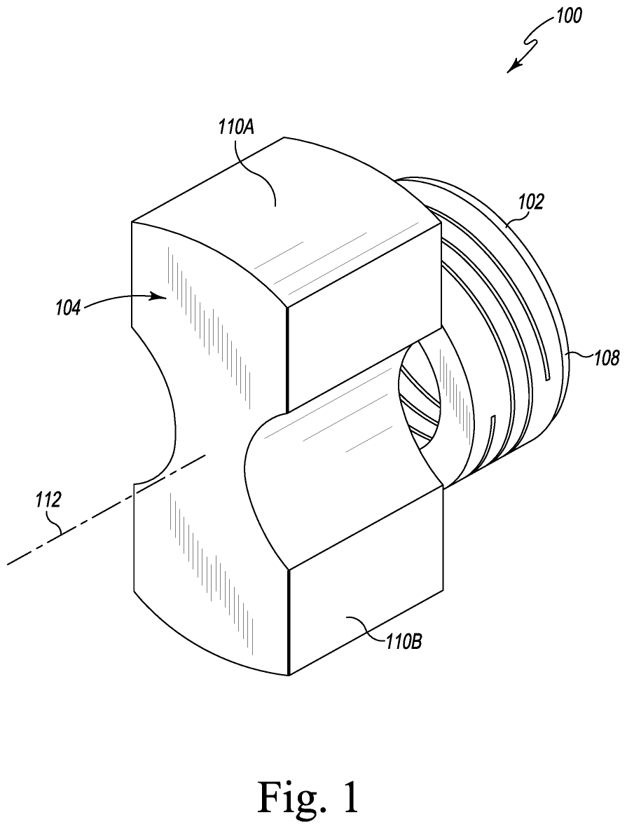

Various embodiments of the multiple frequency vibration attenuation device disclosed herein may attenuate vibrations at two or more different frequencies. FIG. 1 illustrates an embodiment of a multiple frequency vibration attenuation device, indicated generally at 100. The multiple frequency vibration attenuation device 100 includes a spring 102 and a mass 104 attached to one end of the spring 102. In some embodiments, the mass 104 may not attach to anything other than the spring 102. In some embodiments, the spring 102 may be a wire wound spring. In other embodiments, such as that illustrated herein, the spring 102 may be a machined spring such as those available from Helical Products Company, 901 West McCoy Lane, Santa Maria, Calif. 93455.

In some embodiments, the spring 102 and the mass 104 are machined from a single piece of material, such as metal, plastic, or other machinable materials, for example. When making the spring 102 as a machined spring, bar stock is first machined into a thick wall tube form, attachment features are added, and then a helical slot is cut, thereby producing multiple coils. When deflected, these coils provide the desired elasticity. In addition to machining, the multiple frequency vibration attenuation device 100 may be made by other processes, such as 3D printing, molding, and various other methods known in the art.

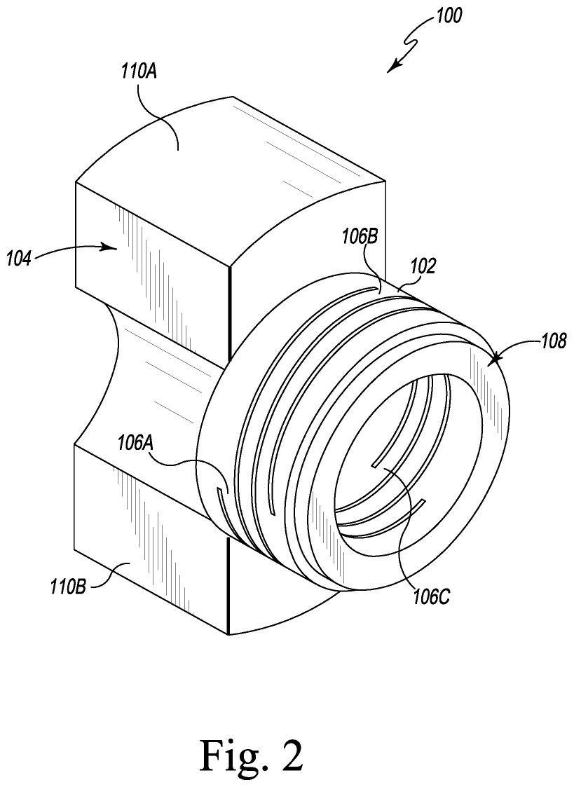

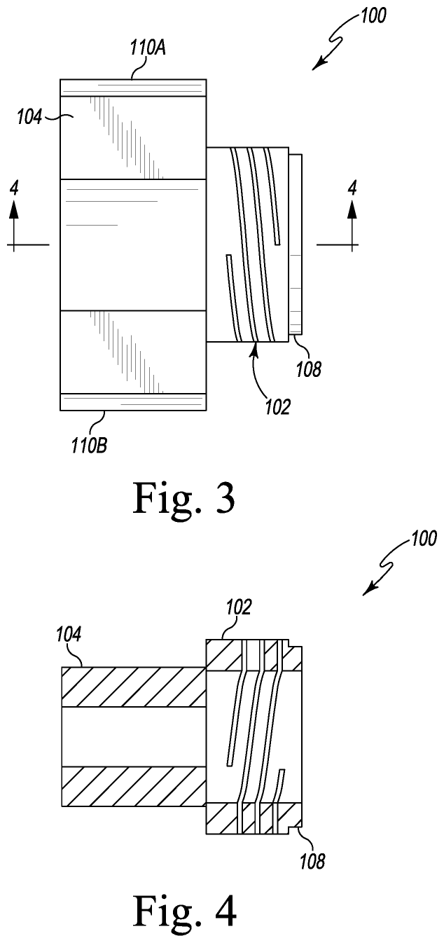

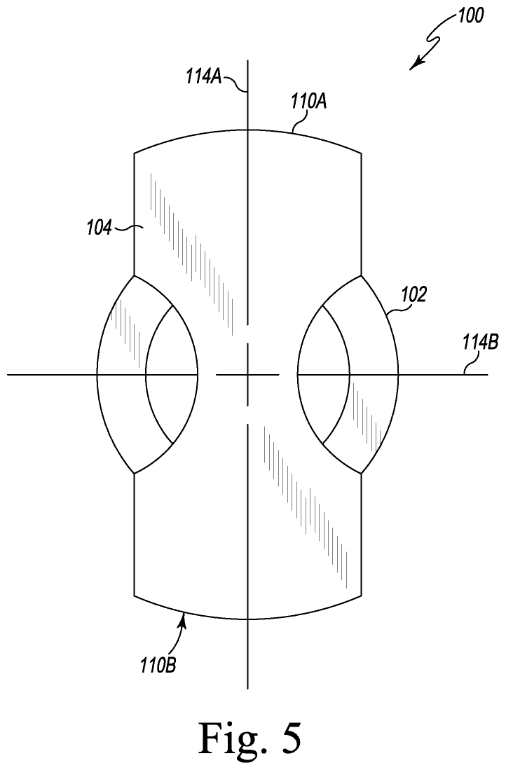

When using a machined spring, the spring 102 may have any number of starts 106. The spring 102 in FIGS. 1-5 includes three starts 106A, 106B, and 106C, as best seen in FIG. 2. The starts 106A, 106B, and 106C produce six separate slots in the spring 102 and therefore three separate coils. The cross-sectional shape of the coils may be square, rectangular (radial or longitudinal) or trapezoidal, depending on the shape of the slot that is machined into the spring 102. In some embodiments, the spring 102 will experience lateral bending during various portions of its operation, and trapezoidal coils have the benefit of allowing for additional lateral motion without coil contact. In some embodiments, the lateral bending rate of the spring 102 is the same in any direction. The spring 102 may have an attachment feature 108 of any desired shape at its proximal end to facilitate coupling the multiple frequency vibration attenuation device 100 to the aircraft or other structure to be attenuated. The multiple frequency vibration attenuation device 100 may attach to the aircraft or other structure at one or more locations.

The mass 104 is formed in a non-radially symmetric shape to allow for attenuation at two frequencies. In the illustrated embodiment, the mass 104 is bilobed, with the majority of its mass concentrated in lobes 110A and 110B. Lobe 110A is located 180 degrees from lobe 110B with respect to the longitudinal axis 112 of the multiple frequency vibration attenuation device 100. Altering the size and/or position of these lobes may change the frequencies the device 100 may attenuate. For example, changing the mass lobes or moving them farther out from the longitudinal axis 112 may change the frequencies the device 100 attenuates. Although the illustrated embodiment is bilobed, any non-radially symmetric shape may be used for the mass 104.

The shape and mass of the mass 104 is dependent on the spring rate and lateral bending rate of the spring 102, and the frequencies that are desired to be attenuated. Natural frequency, also known as eigenfrequency, is the frequency at which a system tends to oscillate in the absence of any driving or damping force. Free vibrations of an elastic body are called natural vibrations and occur at the natural frequency. Natural vibrations are different from forced vibrations that happen at a frequency of applied force (forced frequency). If the forced frequency is equal to the natural frequency, the amplitude of vibration increases many fold. This phenomenon is known as resonance.

Machined springs can easily be used in lateral translation. Lateral translation occurs when one end of a spring is anchored and the other end is laterally displaced by a force plus a moment to insure the end faces of the spring remain parallel. In an embodiment, the multiple frequency vibration attenuation device 100 is designed to have two (or more) natural frequencies that match the vibration frequencies of an aircraft that are desired to be attenuated. When subjected to one of these frequencies by the vibrating aircraft, the multiple frequency vibration attenuation device 100 resonates and dissipates much of the vibration energy from the aircraft (or other system) as this energy is used to move the spring 102 and the mass 104. This in turn may lead to better damping across the entire system, for example an aircraft system.

The multiple frequency vibration attenuation device 100 may be tuned to specific operational frequencies of an aircraft system. This may be done by altering either the spring rate or the mass 104 coupled to the spring 102, so that the modal (natural) frequencies of the spring-mass combination match the modal frequencies of the areas of concern around the aircraft system. Using an asymmetric mass may also require that each of the moments of inertia of the mass be determined so that multiple modal frequencies may be achieved.

The multiple frequency vibration attenuation device 100 may oscillate (through lateral translation, for example) at a first frequency on a first transverse axis 114A oriented in a first direction and oscillate (through lateral translation, for example) at a second frequency on a second transverse axis 114B oriented in a second direction, 90 degrees from the first direction. For example, when the aircraft takes off, the spring may oscillate to attenuate the first frequency, then the oscillation may change 90° to attenuate the second frequency while the aircraft is cruising.

In one embodiment, the two frequencies at which the multiple frequency vibration attenuation device 100 oscillates may include 97 Hz and 120 Hz. In one embodiment, the two frequencies at which the multiple frequency vibration attenuation device 100 oscillates may include 97.5 Hz and 120 Hz. In one embodiment, the two frequencies at which the multiple frequency vibration attenuation device 100 oscillates may include 98 Hz and 120 Hz.

The specific dimensions of the mass 104 may be determined using a computer simulated system model, through multiple design iterations, to achieve a design that has a modal response at the desired frequencies of concern. An aircraft system may include 120 multiple frequency vibration attenuation devices 100 installed around the aircraft in some embodiments. Due to the unwanted aircraft system energy being consumed by vibrating the multiple frequency vibration attenuation devices 100, the vibration in the aircraft system may be reduced to acceptable levels.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A multiple frequency vibration attenuation device, comprising:
a spring comprising a first end and a second end, wherein a longitudinal axis of the spring extends through the first and second ends; and
a mass attached to the first end of the spring;
wherein the device comprises at least two natural frequencies; and
wherein the mass is not attached to anything other than the spring.

2. The device of claim 1, wherein the device oscillates at a first natural frequency when the spring laterally translates on a first transverse axis oriented in a first direction, and oscillates at a second natural frequency when the spring laterally translates on a second transverse axis oriented in a second direction.

3. The device of claim 2, wherein the second direction is oriented 90 degrees from the first direction.

4. The device of claim 1, wherein the at least two natural frequencies comprise 97 Hz and 120 Hz.

5. The device of claim 1, wherein the at least two natural frequencies comprise 97.5 Hz and 120 Hz

6. The device of claim 1, wherein the at least two natural frequencies comprise 98 Hz and 120 Hz.

7. The device of claim 1, wherein the at least two natural frequencies are tuned to match a plurality of vibrational frequencies of a structure to which the device is attached.

8. The device of claim 1, wherein the mass is non-radially symmetrically shaped.

9. The device of claim 8, wherein the mass is bilobed.

10. The device of claim 1, wherein the spring comprises a plurality of coils, the plurality of coils formed by a plurality of helical cuts into a cylinder.

11. The device of claim 10, wherein the plurality of helical cuts determines a lateral bending rate of the spring.

12. The device of claim 11, wherein the lateral bending rate is the same in a plurality of directions.

13. The device of claim 1, wherein the mass comprises a shape and a size which is determined based on a spring rate and a lateral bending rate of the spring, and a plurality of frequencies selected for attenuation.

14. A device for attenuating vibration frequencies of an aircraft, comprising:
a spring comprising a first end and a second end, wherein a longitudinal axis of the spring extends through the first and second ends; and
a mass attached to the first end of the spring;
wherein the device comprises at least two natural frequencies;
wherein the mass is not attached to anything other than the spring; and
wherein the second end of the spring is constructed and arranged to attach to the aircraft.

15. The device of claim 14, wherein the device oscillates at a first natural frequency when the spring laterally translates on a first transverse axis oriented in a first direction, and oscillates at a second natural frequency when the spring laterally translates on a second transverse axis oriented in a second direction,

16. The device of claim 15, wherein the second direction is oriented 90 degrees from the first direction.

17. The device of claim 14, wherein the at least two natural frequencies comprise 97 Hz and 120 Hz.

18. The device of claim 14, wherein the at least two natural frequencies comprise 97.5 Hz and 120 Hz.

19. The device of claim 14, wherein the at least two natural frequencies comprise 98 Hz and 120 Hz.

20. The device of claim 14, wherein the at least two natural frequencies are tuned to match a plurality of vibrational frequencies of the aircraft to which the device is attached.

21. The device of claim 14, wherein the mass is non-radially symmetrically shaped.

22. The device of claim 21, wherein the mass is bilobed.

23. The device of claim 14, wherein the spring comprises a plurality of coils, the plurality of coils formed by a plurality of helical cuts into a cylinder.

24. The device of claim 23, wherein the plurality of helical cuts determine a lateral bending rate of the spring.

25. The device of claim 24, wherein the lateral bending rate is the same in a plurality of directions.

26. The device of claim 14, wherein the mass comprises a shape and a size which is determined based on a spring rate and a lateral bending rate of the spring, and a plurality of frequencies selected for attenuation.
